(19) United States
(12) Patent Application Publication
(10) Pub. No.: US 2011/0109761 A1
(43) Pub. Date: May 12, 2011

(54) IMAGE DISPLAY METHOD AND APPARATUS

(75) Inventors: Shinichi SHIMOTSU, Kanagawa-ken (JP); Yuji Nishio, Kanagawa-ken (JP)

(73) Assignee: FUJIFILM Corporation, Tokyo (JP)

(21) Appl. No.: 12/939,667

(22) Filed: Nov. 4, 2010

(30) Foreign Application Priority Data
Nov. 12, 2009 (JP) 258665/2009

(51) Int. Cl. H04N 5/228

(52) U.S. Cl. 348/222.1; 348/E05.031

(57) ABSTRACT

An image display apparatus for displaying a composite image of an ordinary image and a special image which allows instantaneous recognition of the position of a portion appearing in the fluorescence image in the ordinary image without impairing visible information of the ordinary image. The apparatus includes a light emission unit for emitting ordinary light and special light directed to an observation area and an imaging unit having an ordinary image sensor for capturing an ordinary image by photoelectrically converting reflection light reflected from the observation area irradiated with the ordinary light and a special image sensor for capturing a special image by photoelectrically converting light emitted from the observation area irradiated with the special light and is controlled such that a charge storage amount stored in the special image sensor for each frame is periodically changed.

### BACKGROUND OF THE INVENTION

1. Field of the Invention

The present invention relates to an image display method and apparatus for displaying a composite image of an ordinary image captured by directing ordinary light to an observation area and a special image captured by directing special light to the observation area.

2. Description of the Related Art

Endoscope systems for observing tissues of body cavities are widely known and an electronic endoscope system that captures an ordinary image of an observation area in a body cavity by directing white light to the observation area and displaying the captured ordinary image on a monitor screen is widely used.

As one type of such endoscope systems described above, a fluorescence endoscope system that obtains a autofluorescence image by directing excitation light to an observation area and capturing an image of autofluorescence emitted from the observation area, in addition to an ordinary image, and displays these images on a monitor screen is proposed as described, for example, in Japanese Unexamined Patent Publication No. 2005-204905.

Further, as one of such fluorescence endoscope systems, a system that captures a fluorescence image of a blood vessel by administering, for example, indocyanine green into a body in advance and detecting ICG fluorescence in the blood vessel by directing excitation light to the observation area is proposed.

Here, it is desirable that the ordinary image and fluorescence image are displayed at the same time in an easily viewable manner in the fluorescence endoscope system described above.

As for the method of displaying the ordinary image and fluorescence image, a method in which an ordinary image and a fluorescence image are displayed side by side on a single monitor or a method in which an ordinary image and a fluorescence image are switchedly displayed on a single monitor may be used.

Japanese Unexamined Patent Publication No. 2003-126014 proposes a method in which a fluorescence image signal is allocated to one of three RGB channels of a display and a pseudo color fluorescence image is displayed on an ordinary image.

Now, for example, if a blood vessel is observed using ICG described above, the fluorescence image may indicate a blood vessel under fat which does not appear in the ordinary image. But, the fluorescence image is a monochrome image and represents only a portion of a blood vessel from where fluorescence is emitted. This makes it extremely difficult to understand precisely where a blood vessel image in the fluorescence image is located in the ordinary image.

In a case where an ordinary image and a fluorescence image are switchedly displayed as described above, it may be possible to make a comparison between the two images, but they can not be compared at the same time. Consequently, it is extremely difficult to understand precisely where a blood vessel image in the fluorescence image is located in the ordinary image.

Further, even in a case where an ordinary image and a fluorescence image are displayed at the same time, the observer needs to make a comparison by alternately observing the images. Thus, it is extremely difficult to instantaneously understand where a blood vessel image in the fluorescence image is located in the ordinary image, thereby causing the observer to feel tired.

Where a pseudo color fluorescence image is displayed on an ordinarily image as in the method proposed in Japanese Unexamined Patent Publication No. 2003-126014, it may be possible somehow to understand where a blood vessel image in the fluorescence image is located in the ordinary image, but the observer needs to get used to the color of pseudo color.

Further, the blood vessel image of the fluorescence image includes a portion common to the blood vessel image of the ordinary image, but it is difficult to instantaneously determine the boundary between a portion presents only in the fluorescence image and the common portion depending on the color of pseudo color.

Still further, as the fluorescence image is displayed in pseudo color, visible information of the ordinary image becomes not understandable at all for a portion overlapping between the fluorescence image and ordinary image.

The present invention has been developed in view of the circumstances described above, and it is an object of the present invention to provide an image display method and apparatus for displaying a composite image by combining an ordinary image and a special image which allows instantaneous recognition of the position of a portion appearing in the fluorescence image in the ordinary image without impairing visible information of the ordinary image.

### SUMMARY OF THE INVENTION

An image display method of the present invention is a method in which ordinary light and special light in a wavelength range different from that of the ordinary light are directed to an observation area to capture an ordinary image by photoelectrically converting reflection light reflected from the observation area irradiated with the ordinary light with an ordinary image sensor and storing a charge obtained by the photoelectrical conversion and a special image by photoelectrically converting light emitted from the observation area irradiated with the special light with a special image sensor and storing a charge obtained by the photoelectrical conversion, and a composite image of the captured ordinary image and special image is displayed,

wherein the emission of the special light is controlled such that a charge storage amount stored in the special image sensor for each frame is periodically changed.

An image display apparatus of the present invention is an apparatus, including:

a light emission unit having an ordinary light source for emitting ordinary light and a special light source for emitting special light in a wavelength range different from that of the ordinary light, the ordinary light and the special light being directed to an observation area;

an imaging unit having an ordinary image sensor for capturing an ordinary image by photoelectrically converting reflection light reflected from the observation area irradiated with the ordinary light and storing a charge obtained by the photoelectrical conversion, and a special image sensor for capturing a special image by photoelectrically converting light emitted from the observation area irradiated with the special light and storing a charge obtained by the photoelectrical conversion;

a display unit for displaying a composite image of the ordinary image and the special image captured by the imaging unit; and

a light source control unit for controlling the special light source such that a charge storage amount stored in the special image sensor for each frame is periodically changed.

In the image display apparatus of the present invention described above, the light source control unit may be a unit that causes the special light source to emit the special light at an interval different from an imaging interval of the special image sensor.

Further, the light source control unit may be a unit that controls the special light source such that the special light is emitted from the special light source at an interval based on an imaging interval of the special image sensor and a pulse width of the special light is periodically changed.

Still further, the light source control unit may be a unit that controls the special light source such that the special light is emitted from the special light source at an interval based on an imaging interval of the special image sensor and amplitude of the special light source is periodically changed.

According to the image display method and apparatus of the present invention, a charge storage amount stored in the special image sensor for each frame is periodically changed. This allows a special image in a composite image to be periodically displayed in high/low intensity, whereby the position of a portion appearing in the fluorescence image in the composite image can be recognized instantaneously and visible information of the ordinary image can also be recognized while the fluorescence image is displayed in high/low intensity.

Further, in the image display method and apparatus of the present invention, if the special light is caused to be emitted from the special light source at an interval different from an imaging interval of the special image sensor, the charge storage amount of the special image sensor can be periodically changed by a simple structure.

Still further, advantageous effects identical to those described above may also be obtained by controlling the pulse width or amplitude of the special light to be periodically changed.

### BRIEF DESCRIPTION OF THE DRAWINGS

FIG. 1 is an overview of an abdominoscope system that employs an embodiment of the image display apparatus of the present invention.

FIG. 2 is a schematic configuration diagram of the rigid insertion section shown in FIG. 1.

FIG. 3 is a schematic configuration diagram of the imaging unit shown in FIG. 1.

FIG. 4 is a block diagram of the image processing unit and light source unit shown in FIG. 1, illustrating schematic configurations thereof.

FIG. 5 is a block diagram of the image processing section shown in FIG. 4, illustrating a schematic configuration thereof.

FIG. 6 is a timing chart illustrating the relationship between the emission interval of special light onto an observation area, and the imaging interval of a high sensitivity image sensor and a charge storage amount stored in the high sensitivity image sensor for each frame.

FIG. 7 illustrates, by way of example, a periodical change of a fluorescence image signal.

FIG. 8 illustrates, by way of example, an ordinary image, a fluorescence image, and composite images thereof.

FIG. 9 illustrates an alternative embodiment of the light source unit.

FIG. 10 illustrates, by way of example, an emission pattern when special light is subjected to pulse width modulation.

FIG. 11 illustrates, by way of example, an emission pattern when special light is subjected to amplitude modulation.

FIG. 12 illustrates an alternative embodiment of the image processing section.

FIG. 13 illustrates, by way of example, a blood vessel image V1 represented by an ordinary blood vessel image signal, a blood vessel image V2 represented by a fluorescence blood vessel image signal, and deep blood vessel images V3, V4 represented by a deep blood vessel image signal.

### DESCRIPTION OF THE PREFERRED EMBODIMENTS

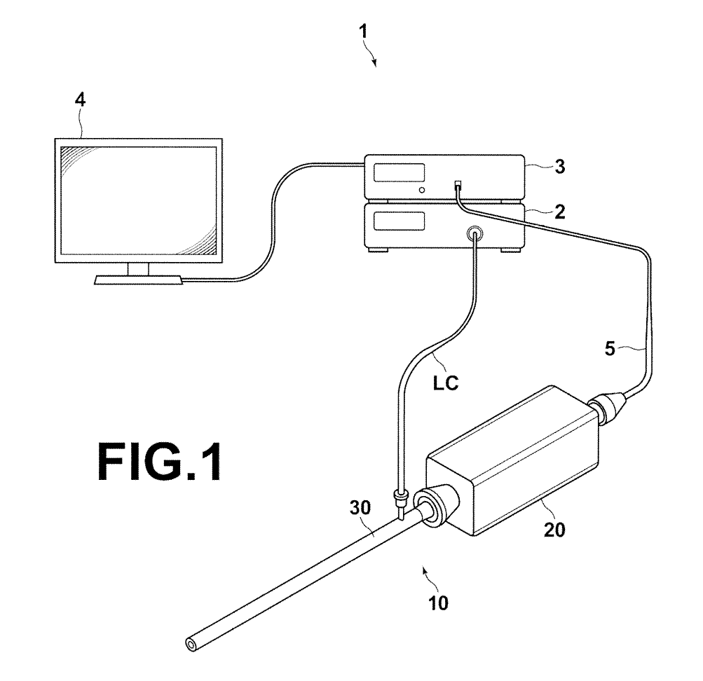

Hereinafter, an abdominoscope system that employs an embodiment of the image display apparatus of the present invention will be described in detail with reference to the accompanying drawings. FIG. 1 is an overview of abdominoscope system 1 of the present embodiment, illustrating a schematic configuration thereof.

As shown in FIG. 1, abdominoscope system 1 includes light source unit 2 for emitting ordinary light of white light and special light, rigid endoscope imaging device 10 for guiding and directing ordinary light and special light emitted from light source unit 2 to an observation area and capturing an ordinary image based on reflection light reflected from the observation area irradiated with ordinary light and a fluorescence image based on fluorescence emitted from the observation area irradiated with the special light, image processing unit 3 for performing predetermined processing on an image signal captured by rigid endoscope imaging device 10, and monitor 4 for displaying an ordinary image and a fluorescence image of the observation area based on a display control signal generated in image processing unit 3.

As shown in FIG. 1, rigid endoscope imaging device 10 includes rigid insertion section 30 to be inserted into an abdominal cavity and imaging unit 20 for capturing an ordinary image and a florescence image of an observation area guided by the rigid insertion section 30.

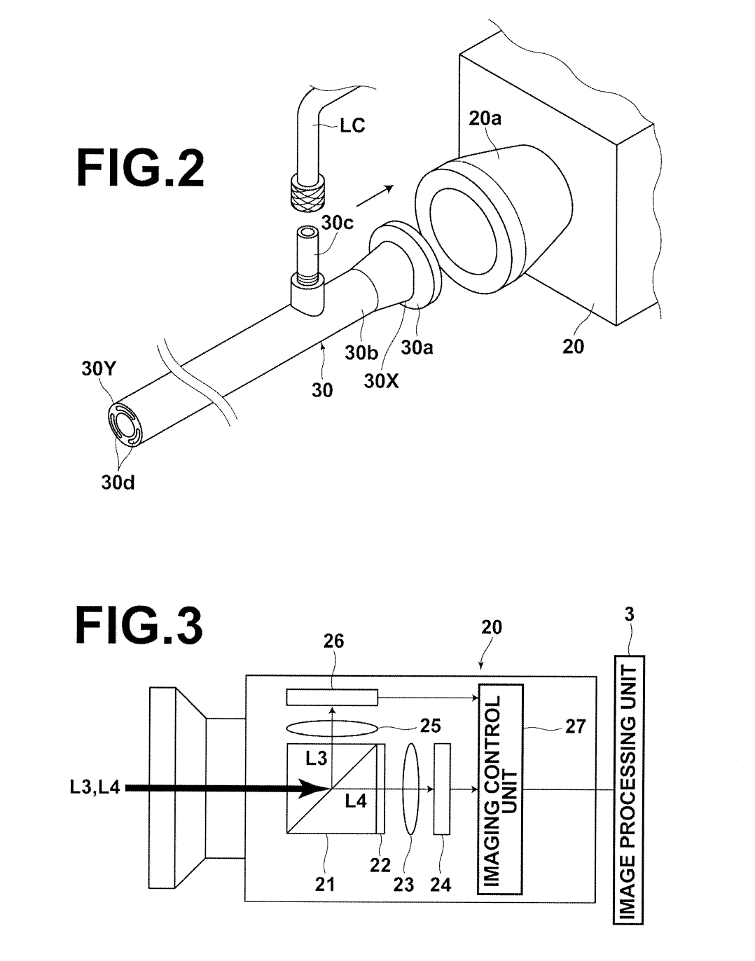

Rigid insertion section 30 and imaging unit 20 are detachably connected, as shown in FIG. 2. Rigid insertion section 30 includes connection member 30a, insertion member 30b, cable connection port 30c, and emission window 30d.

Connection member 30a is provided at first end 30X of rigid insertion section 30 (insertion member 30b), and imaging unit 20 and rigid insertion section 30 are detachably connected by fitting connection member 30a into, for example, aperture 20a formed in imaging unit 20.

Insertion member 30b is a member to be inserted into an abdominal cavity when imaging is performed in the abdominal cavity.

Insertion member 30b is formed of a rigid material and has, for example, a cylindrical shape with a diameter of about 5 mm. Insertion member 30b accommodates inside thereof a group of lenses for forming an image of an observation area, and an ordinary image and a fluorescence image of the observation area inputted from second end 30Y are inputted, through the group of lenses, to imaging unit 20 on the side of first end 30X.

Cable connection port 30c is provided on the side surface of insertion member 30b and an optical cable LC is mechanically connected to the port. This causes light source unit 2 and insertion member 30b to be optically coupled through the optical cable LC.

Emission window 30d is provided on the side of second end 30Y of rigid insertion section 30 to emit ordinary light and special light guided through the optical cable LC onto an observation area. Note that a light guide (not shown) for guiding the ordinary light and special light from the cable connection port 30c to emission window 30d is provided inside of insertion member 30b, and emission window 30d emits the ordinary light and special light guided through the light guide onto the observation area.

FIG. 3 is a schematic configuration diagram of imaging unit 20. Imaging unit 20 includes a first imaging system for generating a fluorescence image signal of an observation area by capturing a fluorescence image of the observation area formed by the group of lenses in rigid insertion section 30 and a second imaging system for generating an ordinary image signal of the observation area by capturing an ordinary image of the observation area formed by the group of lenses in rigid insertion section 30. These imaging systems are divided into two orthogonal optical axes by a dichroic prism 21 having spectroscopic properties in which an ordinary image is reflected and a fluorescence image is transmitted.

The first imaging system includes special light cut filter 22 for cutting special light reflected from an observation area and transmitted through dichroic prism 21, first image forming system 23 for forming a fluorescence image L4 outputted from rigid insertion section 30 and transmitted through dichroic prism 21 and special light cut filter 22, and high sensitivity image sensor 24 for capturing the fluorescence image L4 formed by first image forming system 23.

Second imaging system includes second image forming system 25 for forming an ordinary image L3 outputted from rigid insertion section 30 and reflected by dichroic prism 21, and image sensor 26 for capturing the ordinary image L3 formed by second image forming system 25.

High sensitivity image sensor 24 is a device that detects light in the wavelength range of fluorescence image L4 with high sensitivity, then converts, through a photoelectric conversion, the detected light to a fluorescence image signal, and outputs the fluorescence image signal. In the present embodiment, a monochrome CCD (charge coupled device) is used as high sensitivity image sensor 24.

Image sensor 26 is a device that detects light in the wavelength range of an ordinary image, then converts, through a photoelectric conversion, the detected light to an ordinary image signal, and outputs the ordinary image signal. Color filters of three primary colors, red (R), green (G), and blue (B) or of cyan (C), magenta (M), and yellow (Y) are arranged on the imaging surface of image sensor 26 in a Beyer or honeycomb pattern. In the present embodiment, a CCD provided with the color filters described above is used as image sensor 26.

Imaging unit 20 further includes imaging control unit 27. Imaging control unit 27 is a unit that performs CDS/AGC (correlated double sampling/automatic gain control) and A/D conversion on a fluorescence image signal outputted from high sensitivity image sensor 24 and an ordinary image signal outputted from image sensor 26, and outputs the resultant image signals to image processing unit 3 through cable 5 (FIG. 1).

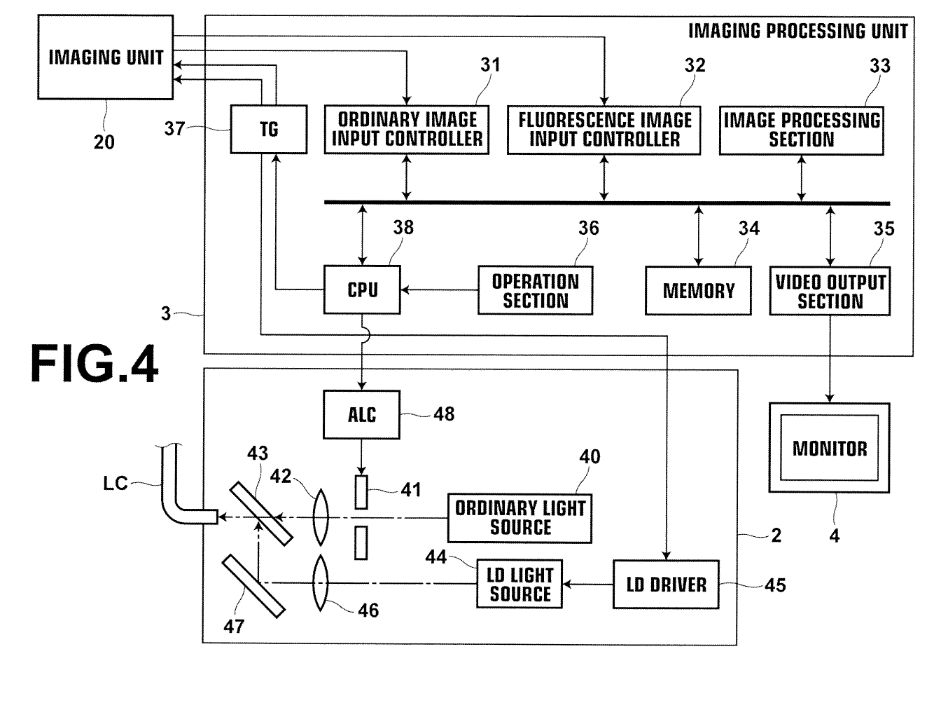

As shown in FIG. 4, image processing unit 3 includes ordinary image input controller 31, fluorescence image input controller 32, image processing section 33, memory 34, video output section 35, operation section 36, TG (timing generator) 37, and CPU 38.

Ordinary image input controller 31 and fluorescence image input controller 32 are each provided with a line buffer having a predetermined capacity and temporarily storing an ordinary image signal or a fluorescence image signal for each frame outputted from imaging control unit 27 of imaging unit 20. Then, the ordinary image signal stored in ordinary image input controller 31 and the fluorescence image signal stored in fluorescence image input controller 32 are stored in memory 34 via the bus.

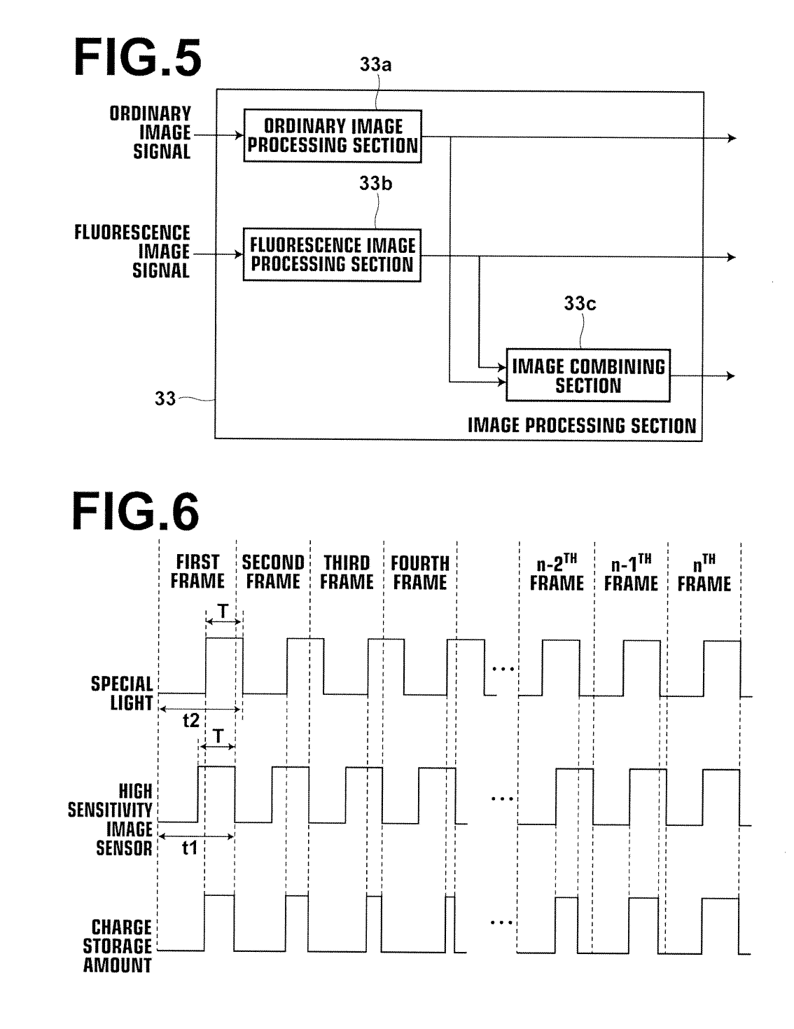

Image processing section 33 receives the ordinary image signal and fluorescence image signal for one frame read out from memory 34, performs predetermined processing on these image signals, and outputs the resultant image signals to the bus. A more specific configuration of image processing section 33 is shown in FIG. 5.

As shown in FIG. 5, image processing section 33 includes ordinary image processing section 33a that performs predetermined image processing, appropriate for an ordinary image, on an inputted ordinary image signal and outputs the resultant image signal, and fluorescence image processing section 33b that performs predetermined image processing, appropriate for a fluorescence image, on an inputted fluorescence image signal and outputs the resultant image signal, and image combining section 33c in which ordinary image signal subjected to the image processing in ordinary image processing section 33a and fluorescence image signal subjected to the image processing in fluorescence image processing section 33b are multiplied by predetermined coefficients respectively and the resultant image signals are added together. Processing performed in each section of image processing section 33 will be described in detail later.

Video output section 35 receives the ordinary image signal and fluorescence image signal, and composite image signal outputted from image processing section 33 via the bus, generates a display control signal by performing predetermine processing on the received signals, and outputs the display control signal to monitor 4.

Operation section 36 receives input from the operator, such as various types of operation instructions and control parameters. TG 37 outputs drive pulse signals for driving high sensitivity image sensor 24 and image sensor 26 of imaging unit 20, and LD driver 45 of light source unit 2, to be described later. CPU 36 performs overall control of the system.

As shown in FIG. 4, light source unit 2 includes ordinary light source 40 that emits ordinary light (white light) L1 having a broad wavelength range from about 400 to 700 nm, condenser lens 42 that condenses the ordinary light L1 emitted from ordinary light source 40, and dichroic mirror 43 that transmits the ordinary light L1 condensed by condenser lens 42 and reflects special light L2, to be described later, thereby inputting the ordinary light L1 and special light L2 to an input end of the optical cable LC. As for ordinary light source 40, for example, a xenon lamp is preferably used. Aperture 41 is provided between ordinary light source 40 and condenser lens 42, and the aperture value thereof is controlled based on a control signal from ALC (automatic light control) 48.

Light source unit 2 further includes LD light source 44 that emits light having a visible to near infrared wavelength in the range from 700 to 800 nm as the special light L2, LD driver 45 that drives LD light source 44, condenser lens 46 that condenses the special light L2 emitted from LD light source 44, and mirror 47 that directs the special light L2 condensed by condenser lens 46 toward dichroic mirror 43.

As for the special light L2, light having a narrower wavelength range than a broad wavelength range of the ordinary light is used. In the present embodiment, ICG (indocyanine green) is administered to a subject in advance as the fluorochrome and near infrared light of 750 to 790 nm is used as the special light L2, but the special light L2 is not limited to the light in the wavelength range described above, and is determined appropriately according to the type of fluorochrome or the type of a living tissue for causing autofluorescence.

LD driver 45 of the present embodiment controls LD light source 44 so that the special light L2 is emitted therefrom at a predetermined interval which will be described later.

An operation of the abdominoscope system of the present embodiment will now be described.

First, rigid insertion section 30 with the optical cable LC attached thereto and cable 5 are connected to imaging unit 20 and power is applied to light source unit 2, imaging unit 20, and image processing unit 3 to activate them.

Then, rigid insertion section 30 is inserted into an abdominal cavity by the operator and the tip of rigid insertion section 30 is placed adjacent to an observation area.

Here, an operation of the abdominoscope system for capturing and displaying an ordinary image will be described first.

Ordinary light L1 emitted from ordinary light source 40 of light source unit 2 is inputted to rigid insertion section 30 through condenser lens 42, dichroic mirror 43, and optical cable LC, and outputted from emission window 30d, whereby the observation area is irradiated with the light.

An ordinary image L3 based on reflection light reflected from the observation area irradiated with the ordinary light L1 is inputted to insertion member 30b from the tip 30Y thereof, which is guided by the group of lenses provided in insertion member 30b and outputted to imaging unit 20.

The ordinary image L3 inputted to imaging unit 20 is reflected by dichroic prism 21 in a right angle direction toward image sensor 26, formed on the imaging surface of image sensor 26 by second image forming system 25, and imaged by image sensor 26.

An ordinary image signal outputted from image sensor 26 is subjected to CDS/AGC (correlated double sampling/automatic gain control) and A/D conversion in imaging control unit 27 and outputted to image processing unit 3 through cable 5.

The ordinary image signal inputted to image processing unit 3 is stored in memory 34 after being temporarily stored in ordinary image input controller 31. Ordinary image signals read out from memory 34 for each frame are subjected to tone correction and sharpness correction in ordinary image processing section 33a of image processing section 33 and sequentially outputted to video output section 35.

Video output section 35 generates a display control signal by performing predetermined processing on the inputted ordinary image signal and outputs the display control signal to monitor 4. Monitor 4, in turn, displays an ordinary image based on the inputted display control signal.

Next, an operation of the abdominoscope system for capturing and displaying a fluorescence image will be described. In the present embodiment, it is assumed that ICG is prescribed to an observation area in advance and fluorescence emitted from the OCG is imaged.

Special light L2 emitted from LD light source 44 of light source unit 2 is inputted to rigid insertion section 30 through condenser lens 46, mirror 47, dichroic mirror 43, and optical cable LC, and outputted from emission window 30d of rigid insertion section 30, whereby the observation area is irradiated with the light.

A fluorescence image L4 based on fluorescence emitted from the observation area by the emission of the special light L2 is inputted to insertion member 30b from the tip 30Y thereof, which is guided by the group of lenses provided in insertion member 30b and outputted to imaging unit 20.

The fluorescence image L4 inputted to imaging unit 20 is formed on the imaging surface of high sensitivity image sensor 24 by first image forming system 23 after passing through dichroic mirror 21 and special light cut filter 22, and imaged by high sensitivity image sensor 24.

Here, in the present embodiment, control is performed such that the emission interval of special light L2 emitted from LD light source 44 differs from the imaging interval of a fluorescence image by high sensitivity image sensor 24 in the imaging process of a fluorescence image described above.

FIG. 6 is a timing chart illustrating the relationship between the emission interval of special light L2 onto an observation area, and the imaging interval (frame interval) of high sensitivity image sensor 24 and a charge storage amount stored in high sensitivity image sensor 24 for each frame. Here, it is assumed that the imaging interval of high sensitivity image sensor 24 is predetermined, and high sensitivity image sensor 24 stores charge signals only for a predetermined charge storage period T for each frame and the stored charge signals are outputted for each frame.

More specifically, LD light source 44 is drive controlled by LD driver 45 such that the emission interval t2 of the special light L2 becomes longer than imaging interval t1 of high sensitivity image sensor 24, as shown in FIG. 6. In the present embodiment, it is assumed that the imaging interval t1 of high sensitivity image sensor 24 is set to 1/10 sec (10 Hz), and emission interval t2 of the special light L2 is set to ⅛ sec (8 Hz). It is also assumed that the pulse width of special light L2 is the same as the charge storage period T of high sensitivity image sensor 24.

By making the emission interval t2 of special light L2 and the imaging interval t1 of high sensitivity image sensor 24 differ from each other, the phases of the respective periods are shifted from each other, as shown in FIG. 6. The charge storage amount stored in high sensitivity image sensor 24 for each frame is proportional to the amount of special light L2 received by the observation area during the charge storage period T of high sensitivity image sensor 24. Consequently, the charge storage amount is gradually changed with the frame, as shown in FIG. 6.

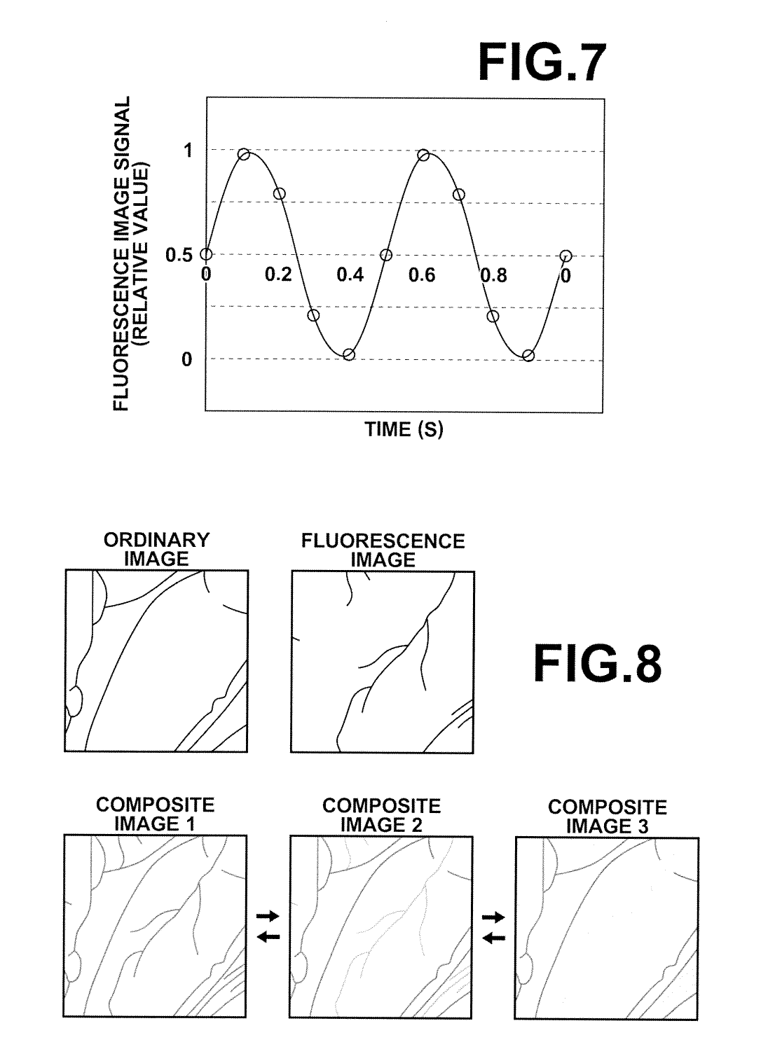

Then, fluorescence image signals according to the charge storage amount for each frame are outputted from high sensitivity image sensor 24. FIG. 7 shows a change in the fluorescence image signal when the imaging interval t1 of high sensitivity image sensor 24 is set to 1/10 sec (10 Hz) and emission interval t2 of the special light L2 is set to ⅛ sec (8 Hz) as in the present embodiment. Note that the vertical axis of FIG. 7 represents the relative value of fluorescence image signal. As shown in FIG. 7, the fluorescence image signal outputted from high sensitivity image sensor 24 is increased and decreased at a given interval with time. When the imaging interval t1 of high sensitivity image sensor 24 is set to 1/10 sec (10 Hz) and emission interval t2 of the special light L2 is set to ⅛ sec (8 Hz) as in the present embodiment, the change interval of the fluorescence image signal is ½ sec (2 Hz), having a beat of 2 Hz. The imaging interval of high sensitivity image sensor 24 and the emission interval of special light L2, however, are not limited to those described above, and other intervals may be employed. Further, the difference between them is not limited to 2 Hz and it may be about 1 to 10 Hz.

Then, the fluorescence image signals outputted from high sensitivity image sensor 24 are subjected to CDS/AGC (correlated double sampling/automatic gain control) and A/D conversion in imaging control unit 27 and outputted to image processing unit 3 through cable 5.

Next, an operation of the abdominoscope system for displaying a composite image based on the ordinary image signals and fluorescence image signals captured by imaging unit 20 in the manner as described above will be described.

The fluorescence image signals inputted to image processing unit 3 are stored in memory 34 after being temporarily stored in fluorescence image input controller 32. Fluorescence image signals read out from memory 34 for each frame are subjected to predetermined image processing in fluorescence image processing section 33b of image processing section 33 and sequentially outputted to image combining section 33c.

In the mean time, ordinary image signals subjected to predetermined image processing in ordinary image processing section 33a of image processing section 33 are also sequentially outputted to image combining section 33c.

Then, in image combining section 33c, each pixel signal of each inputted ordinary image signal is multiplied by a coefficient K1 and each pixel signal of each inputted fluorescence image signal is multiplied by a coefficient K2 and the resultant ordinary image signal and fluorescence image signal are added together. The reason why the image signals are multiplied by the coefficients is that, when the ordinary image signal and fluorescence image signal are added together, the magnitude of the image signal is prevented from being saturated with respect to the amount of data that can be rendered. Thus, as for the coefficients K1 and K2, values that satisfies K1+K2=1 are used. In the present embodiment, it is assumed that K1 and K2 are set to 0.5.

The added-up signal generated in image combining section 33c is outputted to video output section 35, and video output section 35 generates a display control signal by performing predetermined processing on the inputted added-up signal and outputs the display control signal to monitor 4. Monitor 4 displays a composite image based on the inputted display control signal.

FIG. 8 illustrates, by way of example, an ordinary image, a fluorescence image, and composite images thereof. FIG. 8 shows an example fluorescence image in order to make clear distinction between a portion appearing in the ordinary image and a portion appearing in the fluorescence image (blood vessel portion), but it is not necessary to display the fluorescence image.

FIG. 8 shows composite images 1 to 3 of three different states changed with time. As shown in composite images 1 to 3, the portion appearing in the fluorescence image (blood vessel portion) changes in density with time, and displayed in high/low intensity at a rate of two times per second. The high/low intensity display at a predetermined interval allows a portion appearing in the fluorescence image to be clearly recognized.

In the embodiment described above, the fluorescence image signal is caused to beat by making the emission interval t2 of special light L2 and the imaging interval t1 of high sensitivity image sensor 24 differ from each other. But the method is not limited to this and, for example, a method in which the emission interval of special light L2 and the imaging interval of high sensitivity image sensor are set to the same value and the LD driver 45 is controlled such that the pulse width of the special light L2 is changed with time may be used.

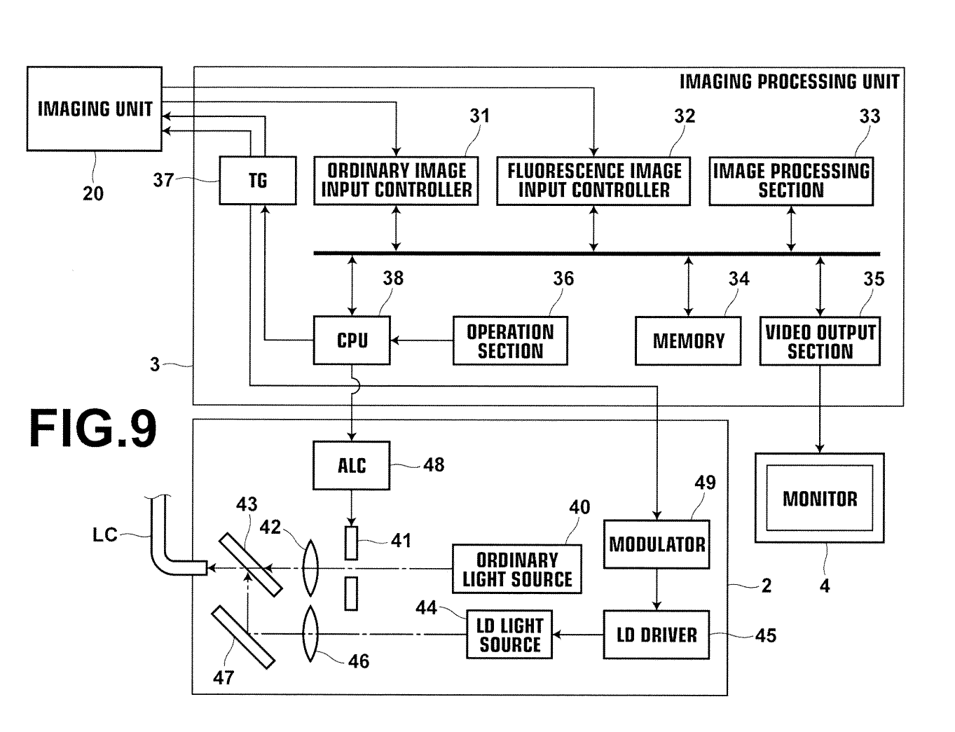

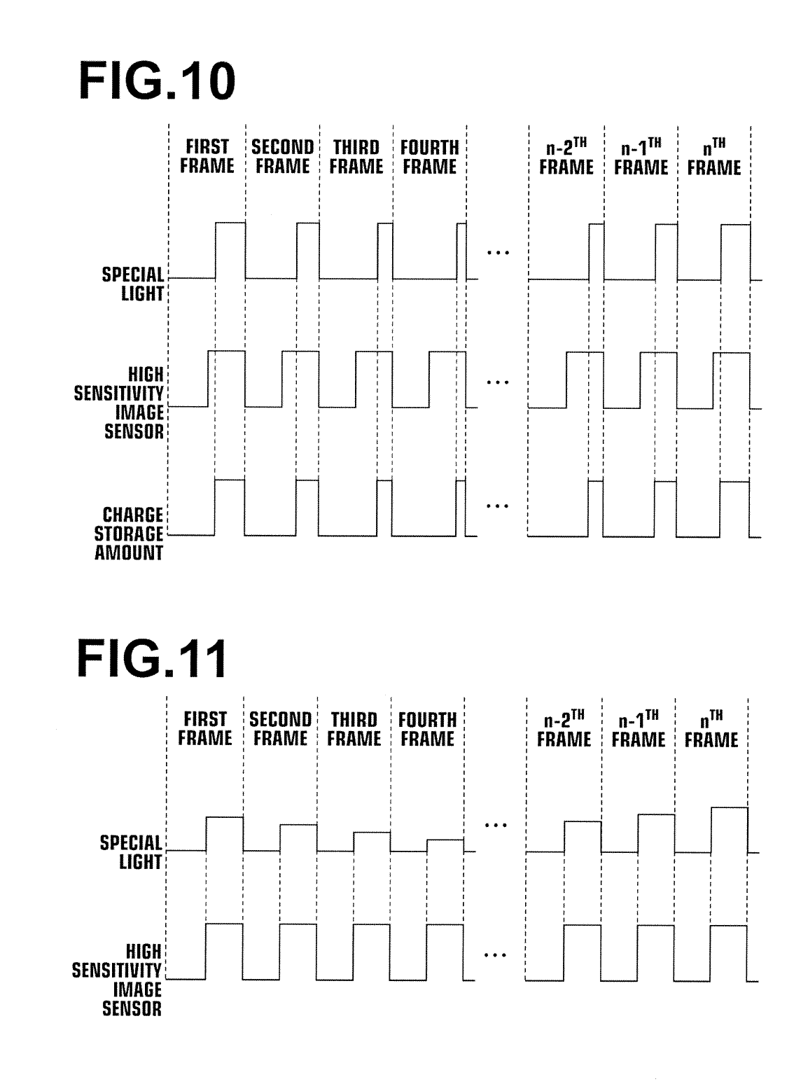

More specifically, as shown in FIG. 9, modulator 49 for modulating the drive voltage of LD driver 45 may be provided and the drive voltage of LD driver 45 may be modulated by modulator 49 so as to be periodically changed. The pattern of the special light L2 when the drive voltage of LD driver 45 is modulated in the manner described above is shown in FIG. 10.

As shown in FIG. 10, the pulse width of the special light L2 is periodically increased and decreased with time. Charges according to the pulse width of the special light L2 are stored in high sensitivity image sensor 24, so that the fluorescence image signal outputted from high sensitivity image sensor 24 may have a beat, as in the embodiment described above.

Further, in the description above, the pulse width of special light L2 is changed, i.e., the drive voltage of LD driver 45 is subjected to pulse width modulation (PWM). But the method is not limited to this, and the drive voltage of LD driver 45 may be subjected to amplitude modulation (AM). The pattern of the special light L2 when the drive voltage of LD driver 45 is subjected to amplitude modulation is shown in FIG. 11. As shown in FIG. 11, by subjecting the drive voltage of LD driver 45 to amplitude modulation, the intensity of the special light L2 is periodically increased and decreased with time. Charges according to the intensity of the special light L2 are stored in high sensitivity image sensor 24, so that the fluorescence image signal outputted from high sensitivity image sensor 24 may have a beat, as in the embodiment described above.

Still further, the entire portion appearing in the fluorescence image is displayed in high/low intensity. But an arrangement may be adopted in which a portion not appearing in the ordinary image and appearing only in the fluorescence image is displayed in high/low intensity. Examples of the portion that appears only in the fluorescence image may include, for example, a deep blood vessel located under fat and the like.

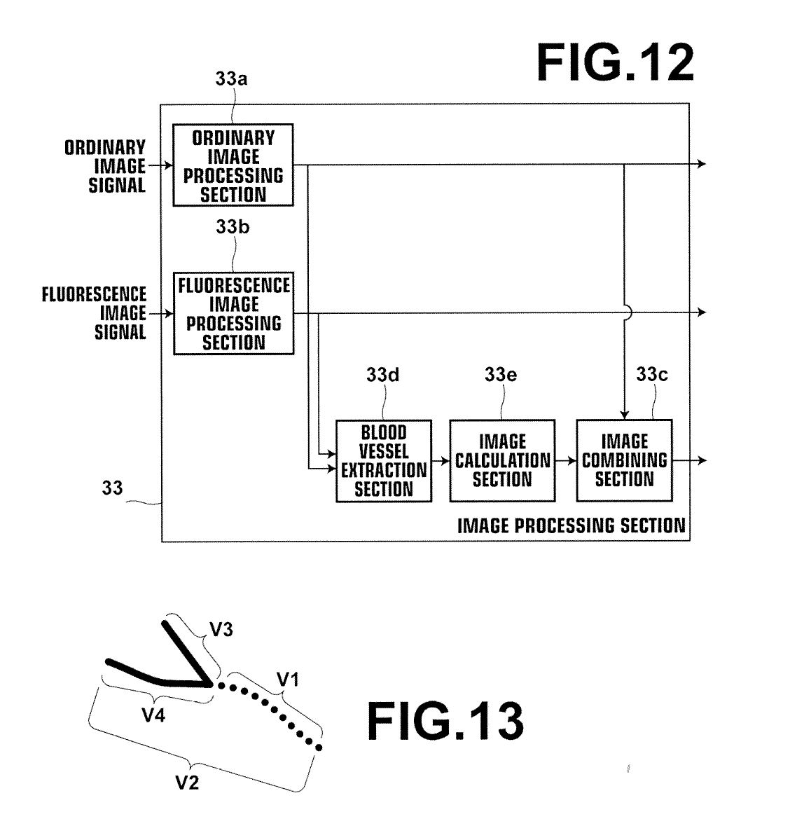

More specifically, blood vessel extraction section 33d and image calculation section 33e are further provided in image processing section 33, as shown in FIG. 12. An operation in this case will be described hereinafter.

First, an ordinary image signal and a fluorescence image signal subjected to predetermined image processing are inputted to blood vessel extraction section 33d. Then, blood vessel extraction is performed on the ordinary image signal and fluorescence image signal in blood vessel extraction section 33d.

The blood vessel extraction may be implemented by performing line segment extraction using edge detection. Edge detection methods include, for example, Canny method using first derivation, a method using a LOG (Laplace of Gaussian) filter that combines Gaussian filtering for noise reduction with a Laplacian filter for edge extraction through secondary differentiation, and the like.

Then, an ordinary blood vessel image signal and a fluorescence blood vessel image signal generated in blood vessel extraction section 33d are outputted to image calculation section 33e and a deep portion image is generated based on these signals. More specifically, a deep blood vessel image signal is generated by subtracting the ordinary blood image signal from the fluorescence blood image signal, and a common blood vessel image signal which is a portion common to the fluorescence blood vessel image signal and the ordinary blood vessel image signal is also generated. The deep blood vessel image signal represents an image of a blood vessel located at a depth in the range from a few tenths of millimeters to several millimeters under fat.

FIG. 13 illustrates, by way of example, a blood vessel image V1 represented by an ordinary blood vessel image signal, a blood vessel image V2 represented by a fluorescence blood vessel image signal, and deep blood vessel images V3, V4 represented by a deep blood vessel image signal. Note that the blood vessel image V1 is also a blood vessel image represented by the common blood vessel image signal.

Then, only the deep blood vessel image signal generated in image calculation section 33e is outputted to image combining section 33c. Then, in image combining section 33c, each pixel signal of each ordinary image signal is multiplied by a coefficient K1 and each pixel signal of each deep blood vessel image signal is multiplied by a coefficient K2 and the resultant ordinary image signal and fluorescence image signal are added together, as in the embodiment described above.

The added-up signal generated in image combining section 33c is outputted to video output section 35, and video output section 35 generates a display control signal by performing predetermined processing on the inputted added-up signal and outputs the display control signal to monitor 4. Monitor 4 displays a composite image based on the inputted display control signal. In the composite image, only the deep blood vessel images V3, V4 are displayed in high/low intensity.

Further, in the present embodiment, a fluorescence image is captured by the first imaging system, but an arrangement may be adopted in which an image of an observation area is captured based on the light absorption characteristics of the observation area when the special light is received by the observation area.

Still further, in the embodiment described above, a blood vessel image is extracted, but images representing other tube portions, such as lymphatic vessels, bile ducts, and the like may also be extracted.

Further, in the embodiment described above, the image display apparatus of the present invention is applied to an abdominoscope system, but the apparatus of the present invention may also be applied to other endoscope systems having a soft endoscope. Still further, the image display apparatus of the present invention is not limited to endoscope applications and may be applied to so-called video camera type medical image capturing systems without an insertion section to be inserted into a body cavity.

What is claimed is:

1. An image display method in which ordinary light and special light in a wavelength range different from that of the ordinary light are directed to an observation area to capture an ordinary image by photoelectrically converting reflection light reflected from the observation area irradiated with the ordinary light with an ordinary image sensor and storing a charge obtained by the photoelectrical conversion and a special image by photoelectrically converting light emitted from the observation area irradiated with the special light with a special image sensor and storing a charge obtained by the photoelectrical conversion, and a composite image of the captured ordinary image and special image is displayed,
wherein the emission of the special light is controlled such that a charge storage amount stored in the special image sensor for each frame is periodically changed.

2. An image display apparatus, comprising:
a light emission unit having an ordinary light source for emitting ordinary light and a special light source for emitting special light in a wavelength range different from that of the ordinary light, the ordinary light and the special light being directed to an observation area;
an imaging unit having an ordinary image sensor for capturing an ordinary image by photoelectrically converting reflection light reflected from the observation area irradiated with the ordinary light and storing a charge obtained by the photoelectrical conversion, and a special image sensor for capturing a special image by photoelectrically converting light emitted from the observation area irradiated with the special light and storing a charge obtained by the photoelectrical conversion;
a display unit for displaying a composite image of the ordinary image and the special image captured by the imaging unit; and
a light source control unit for controlling the special light source such that a charge storage amount stored in the special image sensor for each frame is periodically changed.

3. The image display apparatus of claim 2, wherein the light source control unit is a unit that causes the special light source to emit the special light at an interval different from an imaging interval of the special image sensor.

4. The image display apparatus of claim 2, wherein the light source control unit is a unit that controls the special light source such that the special light is emitted from the special light source at an interval based on an imaging interval of the special image sensor and a pulse width of the special light is periodically changed.

5. The image display apparatus of claim 2, wherein the light source control unit is a unit that controls the special light source such that the special light is emitted from the special light source at an interval based on an imaging interval of the special image sensor and amplitude of the special light source is periodically changed.
